(19) United States
(12) Patent Application Publication
(10) Pub. No.: US 2002/0173315 A1
(43) Pub. Date: Nov. 21, 2002

(54) Method and apparatus for adapting capabilities of a wireless communication system to load requirements

(76) Inventors: Mazen Chmaytelli, San Diego, CA (US); Matthew S. Grob, La Jolla, CA (US)

Correspondence Address: QUALCOMM Incorporated, Attn: Patent Department, 5775 Morehouse Drive, San Diego, CA, 92121-1714, US

(21) Appl. No.: 09/859,932

(22) Filed: May 17, 2001

(51) Int. Cl. H04Q 7/20

(52) U.S. Cl. 455/453; 455/446; 455/423

(57) ABSTRACT

Techniques to adapt capabilities of a base station in a wireless communication system to load requirements. In one method, capabilities of each of a number of configurations for a number of wireless technologies are initially characterized. Each configuration comprises a unique set of channels (i.e., RF carriers) used for data transmission, with each channel implementing a particular wireless technology. The wireless technologies include at least one supportive of voice (e.g., IS-95, cdma2000, W-CDMA, GSM, and so on) and at least one supportive of high data rate (e.g., HDR). The load requirements for the base station are determined, and one of the configurations is selected based on the characterized capabilities and the determined load requirements. The selected configuration is thereafter activated. Hysteresis may be used in selecting the configuration and/or activating the selected configuration. The base station may be adapted continually, periodically, or at scheduled times.

### BACKGROUND

1. Field

The present invention relates generally to data communication, and more particularly to novel and improved techniques for adapting the capabilities of a wireless communication system to changing load requirements to achieve high performance.

2. BACKGROUND

Wireless communication systems are widely deployed to provide various types of communication for a number of users. These systems may be based on code division multiple access (CDMA), time division multiple access (TDMA), frequency division multiple access (FDMA), or some other multiple access techniques. A CDMA system may provide certain advantages over other types of system such as increased system capacity.

Some CDMA systems are capable of supporting multiple types of service such as voice, packet data, and so on. Each type of service is typically characterized by a different set of requirements, some of which are described below.

Voice service typically requires a fixed and common grade of service (GOS) for all users and further imposes (relatively) stringent and fixed delays. For example, the overall one-way delay of speech frames may be specified to be less than 100 msec. These requirements may be satisfied by providing a fixed (and guaranteed) data rate for each user (e.g., via a dedicated traffic channel assigned to the user for the duration of a communication session) and ensuring a maximum (tolerable) error rate for speech frames independent of the link conditions. To maintain the required error rate at a given data rate, a higher allocation of resources (e.g., more transmit power) is required for a user having a degraded link.

In contrast, packet data service may be able to tolerate different GOS for different users and may further be able to tolerate variable amounts of delays. The GOS of a data service may be defined as the total delay incurred in the error free transfer of a data message. Because varied GOS and delays can be tolerated, the transmission delay can be a parameter used to optimize the efficiency of a data communication system.

A wireless communication system can be designed and operated to support both types of service. Such a system may first allocate resources to voice users requiring a fixed GOS and shorter delays and may then allocate any remaining available resources to packet data users whom can tolerate longer delays. However, a system that supports both voice and packet data on the same modulated signal (i.e., same RF carrier or “channel”) necessarily makes certain compromises in the designed features. The frame sizes, coding and interleaving schemes, control and signaling methods, and delay budgets that provide optimal performance for voice and packet data transmissions are likely to be different. Moreover, because of the bursty nature of packet data, the load and thus the resources required to support packet data transmission can fluctuate widely over time. The rapid and wide fluctuation in the packet data load can make it challenging to efficiently allocate resources and support both voice and packet data via a single system designed to support both voice and packet data.

There is therefore a need in the art for techniques to efficiently support both voice and packet data services in a wireless communication system.

### SUMMARY

Aspects of the invention provide techniques to concurrently support both voice and packet data services in a manner to provide high performance for both types of services. It is recognized that different wireless technologies have different characteristics and capabilities, and different types of communication (e.g., voice and packet data) also have different characteristics and requirements. High performance can thus be achieved by selecting the proper combination of wireless technologies having capabilities that best match the system load requirements.

For many wireless communication systems, the total available system bandwidth is sufficient to support multiple RF carriers. Each wireless technology is typically designed to operate based on a particular required bandwidth, which is 1.2288 MHz for some CDMA technologies. The total available system bandwidth may thus be partitioned into a number of frequency bands, each of which may then be used to support one RF carrier (i.e., one “channel”) of a particular wireless technology. The number of RF carriers and the specific combination of wireless technologies that may be concurrently supported by the total available system bandwidth are dependent on the specific designs of the wireless technologies available for consideration.

A specific embodiment of the invention provides a method for adapting capabilities of a base station in a wireless communication system to load requirements. In accordance with the method, capabilities of each of a number of configurations for a number of wireless technologies are initially characterized. Each configuration comprises a unique set of channels (i.e., RF carriers) used for data transmission, with each channel implementing a particular wireless technology. The wireless technologies implemented by the system include at least one technology supportive of voice communication (e.g., IS-95, cdma2000, W-CDMA, GSM, and so on) and at least one technology supportive of high data rate communication (e.g., HDR, described below). The load requirements for the base station are determined, and one of the configurations is selected based on the characterized capabilities of the configurations and the determined load requirements. The selected configuration is thereafter activated. Hysteresis may be used in selecting the configuration and/or activating the selected configuration, as described below. The base station may be adapted continually, periodically, at scheduled times, and so on.

Various aspects, embodiments, and features of the invention are described in further detail below.

### BRIEF DESCRIPTION OF THE DRAWINGS

The features, nature, and advantages of the present invention will become more apparent from the detailed description set forth below when taken in conjunction with the drawings in which like reference characters identify correspondingly throughout and wherein:

FIG. 1 is a diagram of a wireless communication system that supports a number of users and can implement various aspects and embodiments of the invention;

FIGS. 2A and 2B are diagrams illustrating a number of data transmissions for a number of voice users and a number of high rate data users, respectively;

FIG. 3 shows estimates of the achievable performance for various configurations of wireless technologies;

FIG. 4 is a flow diagram of a process to adapt the capabilities of a wireless communication system to the load requirements;

FIG. 5 is a diagram of an embodiment of a wireless communication system that implements multiple wireless technologies;

FIG. 6 is a block diagram of an embodiment of a base station in which the processing units implementing multiple wireless technologies are co-located at the same cell-site and share some common electronics; and

FIG. 7 is a diagram that illustrates the use of hysteresis to prevent toggling between two configurations.

### DETAILED DESCRIPTION

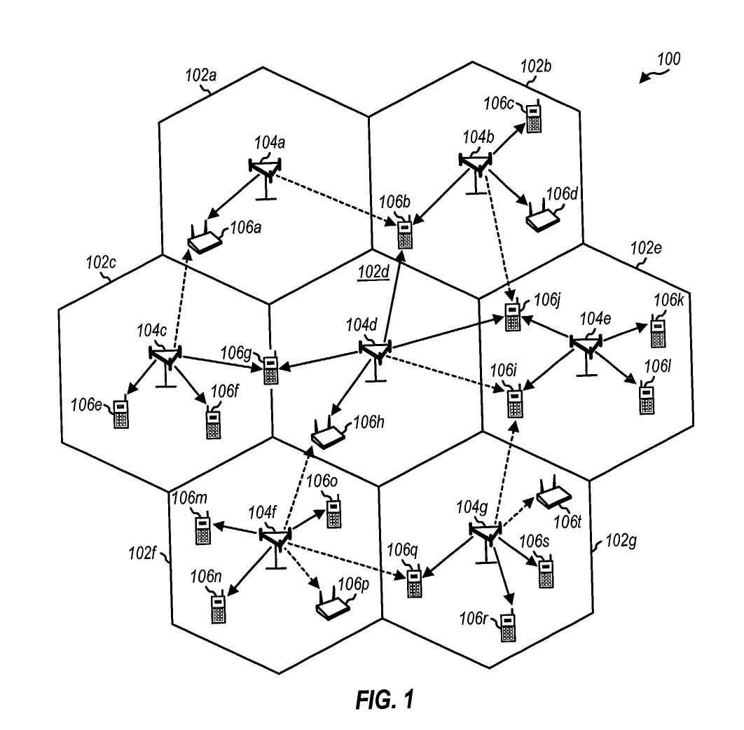

FIG. 1 is a diagram of a wireless communication system 100 that supports a number of users and can implement various aspects and embodiments of the invention. System 100 provides communication for a number of geographic areas 102a through 102g, with each area 102 being serviced by a corresponding base station 104. The base station and its coverage area are often collectively referred to as a cell. Various terminals 106, which may also be referred to as remote terminals or mobile stations, are dispersed throughout the system.

In an embodiment, each terminal 106 may communicate with one or more base station 104 on the forward and reverse links at any given moment, depending on whether the particular wireless technology used for the communication supports soft handoff and whether the terminal is actually in soft handoff. The forward link (i.e., downlink) refers to transmission from the base station to the terminal, and the reverse link (i.e., uplink) refers to transmission from the terminal to the base station.

In FIG. 1, a solid line with an arrow indicates a user-specific data transmission from a base station to a terminal, and a broken line with an arrow indicates that the terminal is receiving a pilot reference and other signaling but no user-specific data transmission from the base station. As shown in FIG. 1, base station 104a transmits data to terminal 106a on the forward link, base station 104b transmits data to terminals 106b, 106c, and 106d, base station 104c transmits data to terminals 106e, 106f, and 106g, and so on. The uplink communication is not shown in FIG. 1 for simplicity.

System 100 may be designed to implement a number of wireless technologies for CDMA, FDMA, TDMA, some other multiple access techniques, or any combination thereof. The CDMA technologies may conform to CDMA standards such as the IS-95, IS-98, cdma2000, IS-856, and W-CDMA standards. The TDMA technologies may conform to standards such as GSM (Global System for Mobile Communications) and its various variants. All these standards are known in the art and incorporated herein by reference.

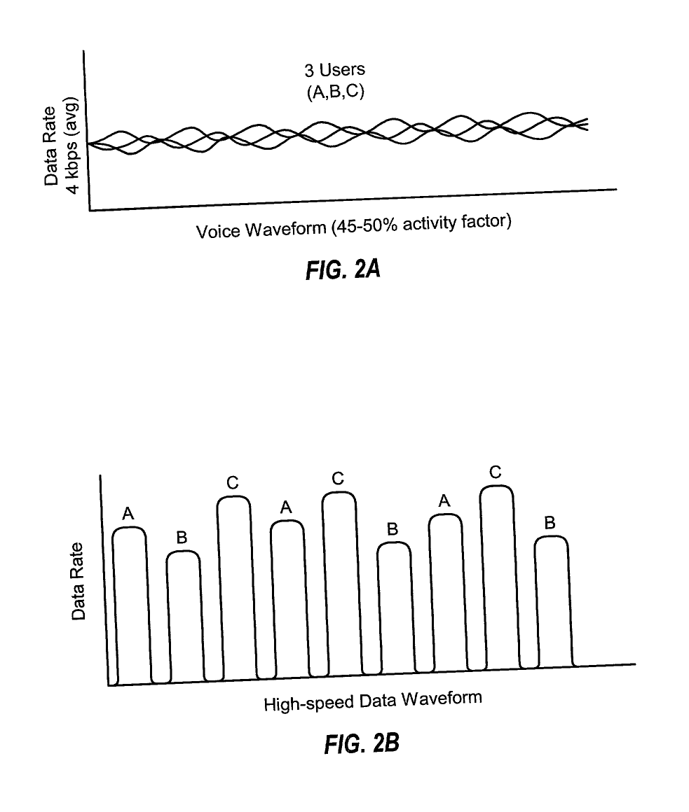

FIG. 2A is a diagram illustrating a number of data transmissions for a number of voice users in a wireless communication system. Many users may be supported concurrently for low rate applications (which include voice and some low to medium rate data services) since each user requires and is allocated a low rate traffic channel. The data transmission for each voice user typically experiences relatively smaller fluctuations than for a data user. For example, eighth rate data may be transmitted for a voice user even during periods of silence for certain CDMA systems. Moreover, due to statistical averaging from a larger number of voice users, the variations in the individual transmissions statistically cancel out, and the aggregate waveform for all data transmissions is relatively uniform.

FIG. 2B is a diagram illustrating a number of data transmissions for a number of high rate data users in a wireless communication system. In the example shown in FIG. 2B, packet data is transmitted for one user at a time in a time division multiplexed (TDM) manner and each user is allocated and uses a large portion of the available resource when selected for data transmission. As a result, statistical averaging does not apply and the overall waveform is bursty in nature.

As shown in FIGS. 2A and 2B, the characteristics of voice transmissions and packet data transmissions are different. FIGS. 2A and 2B also show that the average throughput for the voice transmissions may be much lower than that for the packet data transmissions. For example, the average throughput may be as low as 100 kbps per sector for a voice system that conforms to IS-95 standard. In contrast, the average throughput for a packet data system may be more than 600 kbps per sector for the same system bandwidth (e.g., 1.2288 MHz).

The reason for the lower average throughput for the voice system may be as follows. Since equal QOS needs to be provided for all voice users, a traffic channel of a particular maximum data rate is assigned to each voice user for the duration of a call. For disadvantaged voice users having worse signal-to-noise-plus-interference ratios (SNRs), more resources need to be allocated to these users to maintain the desired level of performance. The disproportionate allocation of resources to disadvantaged users is required to achieve equal QOS but results in a lower overall average throughput for the voice system.

In contrast, for the packet data system, a large portion or all of the resources may be allocated to a particular packet data user at any given moment. Packet data may then be transmitted at the highest data rate supported by the link. Because variable delays may be tolerated, the more advantaged data users may be selected and scheduled for data transmission, subject to certain constraints on fairness. Data transmission may thus be scheduled to take advantage of time diversity resulting from continual changes in the link conditions over time.

In general, a communication system that transmits both voice and packet data on the same modulated signal (i.e., same RF carrier or channel) necessarily makes certain compromises in the designed features. The frame size, coding and interleaving schemes, control and signaling methods, and delay budgets that provide optimal performance for voice transmissions are likely to be different from those for packet data transmissions. Moreover, since packet data is bursty in nature and voice prefers a more controlled environment to achieve the required SNR, it is challenging to schedule packet data transmissions along with voice transmissions. If voice and data transmissions are superimposed on the same RF carrier, clipping may occur and this would degrade the performance of both types of services.

An aspect of the invention provides techniques to concurrently support both voice and packet data services in a manner to provide high performance. It is recognized by the invention that different wireless technologies have different characteristics and capabilities, and different types of communication (e.g., voice and packet data) also have different characteristics and requirements. Thus, high performance is achieved by selecting the proper combination of wireless technologies having capabilities that best match the system load requirements.

It is also recognized by the invention that for many wireless communication systems the total available system bandwidth is sufficient to support multiple RF carriers. Each wireless technology is typically designed to operate based on a particular required bandwidth, which is 1.2288 MHz for some CDMA technologies. The total available system bandwidth may thus be partitioned into a number of frequency bands, each of which may then be used to support one RF carrier (i.e., one channel) of a particular wireless technology. The number of RF carriers and the specific combination of wireless technologies that may be concurrently supported by the total available system bandwidth are dependent on the specific designs of the wireless technologies available for consideration.

Optimizing voice and packet data transmissions on different RF carriers, to the extent possible or practical, can provide improved performance for both types of services since a wireless technology more optimized for each service type may be selected and used for that service. By using different RF carriers for voice and data services, again to the extent possible or practical, voice and data transmissions do not degrade one another. Other advantages and benefits may also be realized such as (1) the avoidance of having to perform difficult load-balancing tasks to transmit voice and packet data on the same RF carrier, (2) simplified system software development and testing, (3) ease of system operation and maintenance, and possibly other benefits.

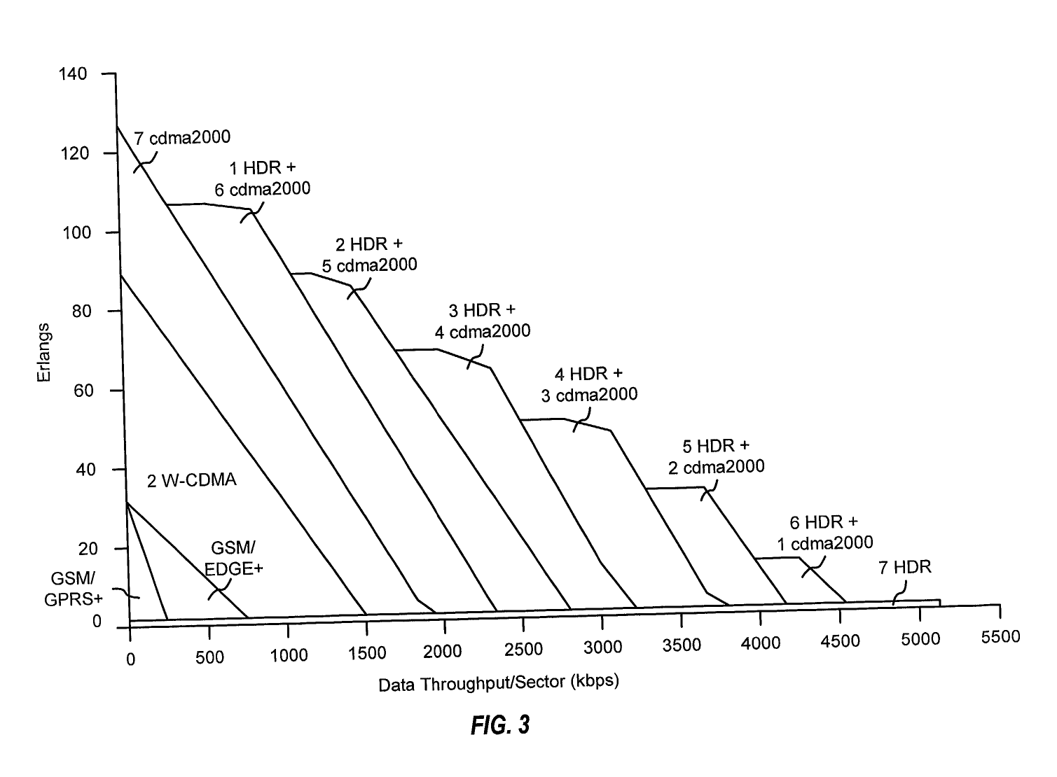

FIG. 3 shows estimates of the achievable performance for various configurations of wireless technologies. The achievable performance is plotted on a two-dimensional graph in which voice performance is expressed in the vertical axis and packet data performance is expressed in the horizontal axis. Voice performance can be quantified in units of Erlangs, and packet data performance can be quantified by the data throughput, which is expressed in units of kbps/sector. For the comparison of various configurations, it is assumed that 10 MHz of system bandwidth is available, no transmit diversity is employed, and the environment and channel model are for macrocellular with 50% ITU Vehicular (A).

The following wireless technologies are evaluated and considered in the comparison: HDR (High Data Rate), cdma2000 1× (or just simply, cdma2000), W-CDMA, GSM/EDGE+, and GSM/GPRS+. HDR is defined by the IS-856 standard. The remaining wireless technologies listed above are similarly defined by corresponding standards. These various standards are known in the art and incorporated herein by reference. Other wireless technologies (e.g., LAS-CDMA) may also be available for deployment and are also within the scope of the invention. However, these technologies are not considered in the comparison for simplicity.

Each wireless technology (or standard, if adopted by a standards body) specifically defines the processing of data prior to transmission over the forward and reverse links. For example, data to be transmitted may be formatted into a defined frame format and processed (e.g., encoded for error correction and/or detection, interleaved, spread, and so on) in accordance with a particular processing scheme. The frame formats and processing defined by a particular wireless technology (e.g., cdma2000) are likely to be different from those for other wireless technologies (e.g., W-CDMA or HDR).

The processing for voice is typically different from that for packet data. For example, since voice is typically low rate and more intolerant to delays, voice data may be formatted into shorter packets, encoded with a coding scheme (e.g., a convolutional code) that can be decoded in a shorter time period, and interleaved over a shorter time interval. In contrast, packet data may be formatted into longer packets, encoded with a coding scheme (e.g., a Turbo code) that may be associated with a longer decoding delay but can provide improved performance, and interleaved over a longer time interval to achieve greater time diversity.

Other design features may also be different for different wireless technologies. For example, the signaling scheme for a wireless technology designed to supports packet data is typically different from one for a wireless technology designed to support voice. Technologies that support packet data are also typically designed to efficiently schedule data transmission, and this design feature may not be implemented fully in technologies designed to support voice.

In general, HDR is optimized for packet data (and does not even support voice), cdma2000 and W-CDMA are optimized for voice and low to medium rate data, and IS-95 and GSM are optimized for voice. IS-95, cdma2000, and HDR can each operate based on a bandwidth of 1.2288 MHz. cdma2000 may also be operated as a 1×, 2×, or 3× system, which respectively requires 1, 2, and 3 times the 1.2288 MHz bandwidth. For simplicity, the 2× and 3× variants of cdma2000 are not considered herein. W-CDMA requires a bandwidth of 5 MHz and GSM/EDGE+ and GSM/GPRS+each requires a bandwidth of 10 MHz.

For the 10 MHz system bandwidth under consideration, the following configurations of wireless technologies may be supported:

1) 7 HDR

2) 6 HDR +1 cdma2000

3) 5 HDR +2 cdma2000

4) 4 HDR +3 cdma2000

5) 3 HDR +4 cdma2000

6) 2 HDR +5 cdma2000

7) 1 HDR +6 cdma2000

8) 7 cdma2000

9) 2 W-CDMA

10) 1 GSM/EDGE+

11) 1 GSM/GPRS+

The first configuration indicates that 7 RF carriers (or channels) of HDR may be supported by the 10 MHz system bandwidth, the second configuration indicates that 6 RF carriers of HDR plus a single RF carrier of cdma2000 may be supported, and so on.

FIG. 3 shows the achievable performance for each configuration listed above. As shown in FIG. 3, the best packet data performance is achieved when the entire 10 MHz system bandwidth is used to support 7 HDR channels. This is as expected since HDR has been optimized for packet data. However, this configuration does not support voice service. As more and more of the available system bandwidth is allocated to cdma2000, the achievable packet data performance decreases but the voice performance improves.

The plots in FIG. 3 can be obtained by first characterizing the performance of each wireless technology available for consideration. The capabilities of each wireless technology (in Erlangs and data throughput) to support various combinations of voice and packet data loads may be characterized. The end points are the maximum achievable Erlangs if all resources are allocated to support voice, and the maximum achievable throughput if all resources are allocated to support packet data.

Based on the available system bandwidth (e.g., 10 MHz in the above example), various configurations of the wireless technologies may be formed such that each configuration is supported by the available system bandwidth. The performance of each configuration can be determined by summing the achievable performance of the individual component that makes up the configuration. For example, the performance for the fourth configuration of 4 HDR plus 3 cdma2000 may be determined by multiplying the characterized performance for HDR by four, multiplying the characterized performance for cdma2000 by three, and summing the results for the two wireless technologies.

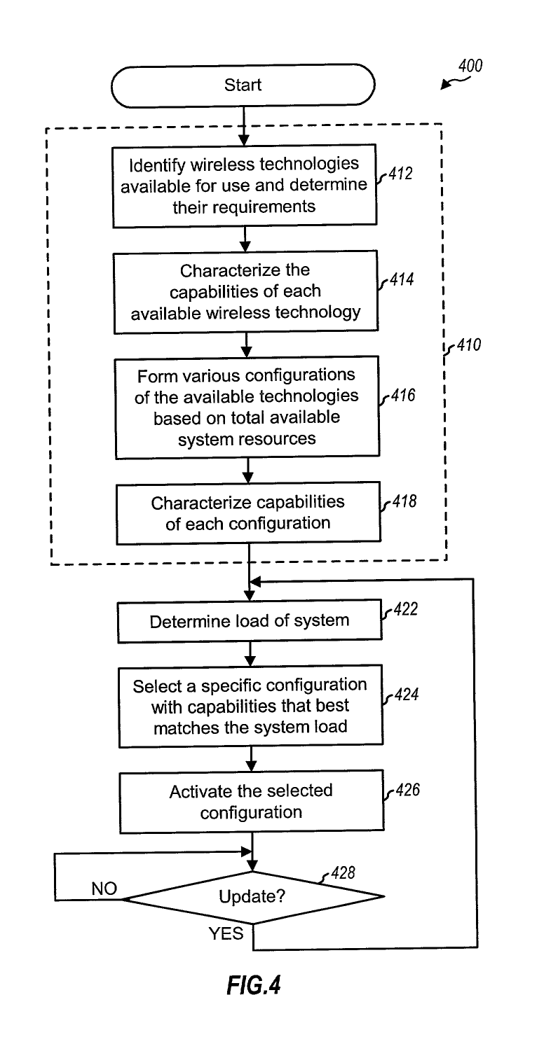

FIG. 4 is a flow diagram of a process 400 to adapt the capabilities of a wireless communication system to the load requirements, in accordance with an embodiment of the invention. Initially, various wireless technologies available for deployment are identified and their requirements are determined, at step 412. The requirements for a particular technology typically includes the bandwidth required to operated one channel of the technology (e.g., 1.2288 MHz for IS-95, HDR, and cdma2000 1×, and 5 MHz for W-CDMA). For each available technology, its capabilities to support various combinations of voice and packet data loads are characterized, at step 414. This characterization may be performed via simulations and/or empirical measurements, and may further be achieved based on different allocations of the available resources to voice and packet data.

Various configurations of the available technologies are then formed based on the total available system bandwidth and the requirements for the available wireless technologies, at step 416. Each configuration may include any combination of one or more wireless technologies and any number of channels for each of the technologies included in the configuration, provided that the aggregate total bandwidth required for all channels of all technologies is supported by the total available system bandwidth. The capabilities of each configuration are then characterized, at step 418. This can be achieved by multiplying the capabilities of each technology in the configuration (determined in step 414) by the number of channels for that technology, and summing the resultant products for all technologies in the configuration. The resultant capabilities for each configuration, as determined in step 418, may be plotted in a graph such as that shown in FIG. 3.

Steps 412 through 418 are typically performed once (e.g., when a system is first deployed) and may be repeated each time the system changes (e.g., a new technology is made available, the total available system bandwidth changes, and so on). The characterized performance for each configuration may be stored and later consulted to determine the best configuration to use for a given load requirement.

During normal operation of the system, the system load is continually, periodically, sporadically, or systematically determined (at scheduled times), at step 422. The system load may be quantified by, e.g., the required Erlangs (which may be inferred from the number of voice users to be supported), the amount of packet data to be transmitted, and so on. Based on the determined system load, a specific configuration with capabilities that best match the system load is selected, at step 424. At the proper instance in time, the selected configuration is then activated, at step 426. This can be achieved as described below.

At step 428, a determination is made whether or not the system configuration should be re-evaluated. In some embodiments, the system load is monitored periodically, e.g., based on a timer. For these embodiments, if the timer expires, then the process returns to step 422 and the system is re-evaluated. In some other embodiments, the system load is monitored at scheduled times. For these embodiments, the process returns to step 422 if the next scheduled time has arrived. For yet some other embodiments, the system load is continually monitored and the system is continually adapted. For all embodiments, thresholds may be used to trigger the switching to a new configuration and safeguards (e.g., hysteresis) may be implemented to avoid continual toggling between different configurations. If it is determined that the system is not to be evaluated yet, at step 428, then the process loops back to step 428 and waits.

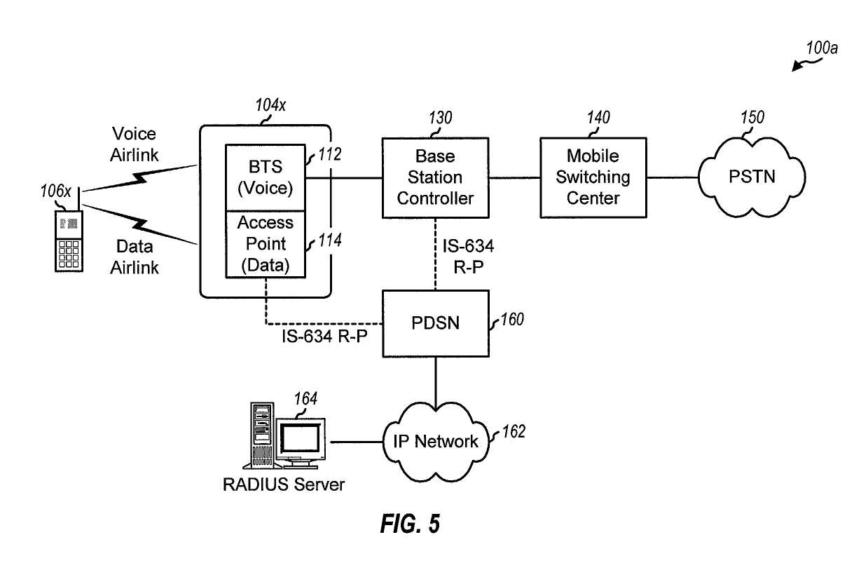

FIG. 5 is a diagram of an embodiment of a wireless communication system 100a that employs multiple wireless technologies and can implement various aspects and embodiments of the invention. System 100a is one implementation for system 100 in FIG. 1.

System 100a includes a number of base stations 104x (only one is shown in FIG. 5) that can deploy a combination of wireless technologies. In the embodiment shown, base station 104x includes a base station transceivers (BTS) 112 and an access point 114. BTS 112 may be used to support voice and possibly low to medium rate data, and may be implemented using various wireless technologies. Such technologies may include IS-95, IS-98, cdma2000, W-CDMA, and others for CDMA, GSM and others for TDMA, and so on. Access point 114 may be used to support high rate packet data, and may be implemented using HDR or some other technologies.

Base station 104x couples to a base station controller (BSC) 130, e.g., via a Ti/El line. BSC 130 further couples to a mobile switching center (MSC) 140 that further couples to a public switched telephone network (PSTN) 150. BSC 130 provides control and coordination for a number of base stations and further directs calls between terminals 106 at one base station to other terminals at other base stations or to other users coupled to PSTN 150. MSC 140 directs calls between terminals 106 and users coupled to PSTN 150. The operation of the BSC, MSC, and PSTN is known in the art and not described herein.

Base station 104x and/or BSC 130 may couple to a packet data serving node (PDSN) 160, e.g., via an “R-P” interface, which is part of an A-interface defined by the IS-634 standard. PDSN 160 couples to an Internet Protocol (IP) network 162 that further couples to one or more servers (only a RADIUS server 164 is shown for simplicity). In general, BSC 130 routes voice calls and PDSN 160 routes packet data calls.

A multi-mode terminal 106x can be used to receive service from any one of the deployed wireless technologies or possibly a combination of these technologies. The hardware and software needed to implement the multi-mode terminals are currently available. For example, application specific integrated circuits (ASICs) that can process both HDR and cdma2000 are available from Qualcomm, Incorporated.

For the multi-technology deployment described above, one or more wireless technologies can be used to efficiently support high-speed packet data services and one or more wireless technologies can be used to efficiently support voice and other delay sensitive services. By using an efficient air-link technology for data service (e.g., the Internet) and a suitable air-link technology for voice service, the multi-technology system can maximize the use of the available air-link resources and thereby provide multiple high quality and cost-effective services to users.

In FIG. 5, BTS 112 and access point 114 symbolically represent the entities used to support voice and packet data services, respectively. BTS 112 and access point 114 can each implement one or more wireless technologies and can each further include one or more processing units, with each processing unit capable of supporting one channel (i.e., one RF carrier). In one embodiment, BTS 112 and access point 114 are implemented as two separate entities that may however be co-located at the same site and share the same set of antennas. These two separate entities may not be coupled together nor share common electronics. In another embodiment, the processing units for BTS 112 and access point 114 are packaged separately but co-located at a single cell-site and share some common electronics. For example, BTS 112 and access point 114 may each include a number of channel cards that are installed in a common rack-mount chassis. This deployment offers flexibility in allowing a service provider to deploy any combination of wireless technologies by simply multiplexing the processing units (i.e., channel cards).

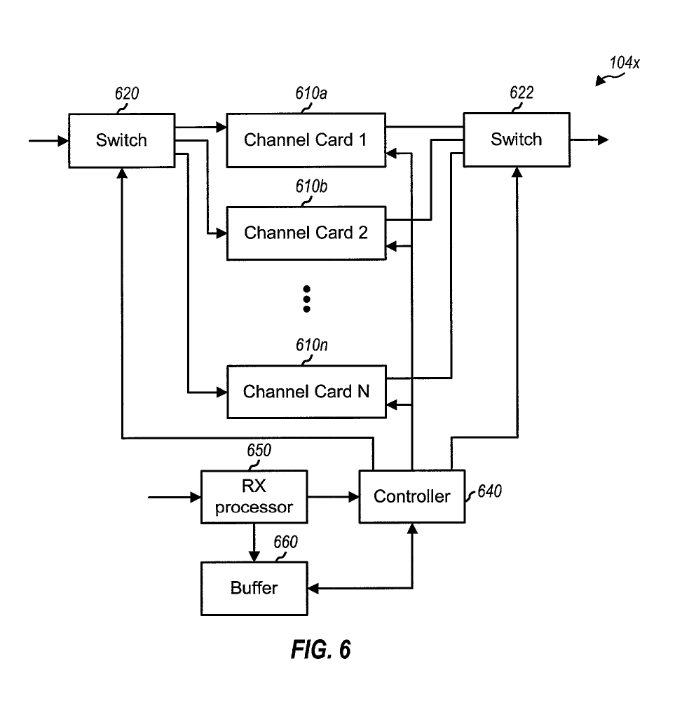

FIG. 6 is a block diagram of an embodiment of base station 104x in which the processing units implementing multiple wireless technologies are co-located at the same cell-site and share some common electronics. In this embodiment, base station 104x includes a number of channel cards 610a through 610n, each of which implements a particular wireless technology and can support one channel (i.e., one RF carrier). Channel cards 610a through 610n couple to an input switch 620 and an output switch 622. Voice and packet data are provided to input switch 620, which then demultiplexes the data to the proper activated channel cards, as determined by one or more control signals received from a controller 640.

Each activated channel card 610 may receive data targeted for a single terminal (e.g., for HDR packet data) or data targeted for a number of terminals (e.g., for voice). Each activated channel card 610 processes (e.g., formats, encodes, interleaves, covers, and spreads) the received data for each recipient terminal based on the particular wireless technology being implemented by the channel card and provides the processed data to output switch 622.

Switch 622 couples the processed data from the activated channel cards, as determined by one or more control signals from controller 640, to a subsequent stage that may comprise a bank of modulators (not shown in FIG. 6). Each modulator further processes and modulates the data designated for a particular RF carrier to provide a respective modulated signal for the channel associated with the RF carrier. In an alternative embodiment, the channel cards can also perform the modulation and each activated channel card provides a respective modulated signal instead of processed data to switch 622.

A receive processor 650 receives requests for voice communication and packet data transmissions from the terminals and stores the requests to a buffer 660. For simplicity, receive processor 650 is symbolically shown as a single unit, but is also typically implemented with a bank of channel cards.

Controller 640 may couple to receive processor 650 and/or buffer 660 to receive information indicative of the system load. As noted above, the system load may be quantified by the number of voice user being supported or requesting connection, the amount of packet data to be transmitted, and so on. Controller 640 may implement one or more schemes to quantify the system load, select the best configuration of channel cards based on the system load, and provide the appropriate control signals to activate the channel cards for the selected configuration.

Various schemes may be used to adapt the system capabilities to the load requirements. In one adaptation scheme, the system load may be monitored continually, periodically, sporadically, or at scheduled times and the system may be adapted based on the determined load requirements. The system load may be quantified by the required Erlangs and data throughput as described above, and may be mapped to a particular point in a graph descriptive of the system capabilities. The configuration with the capabilities that best match the load requirements may then be selected and activated. Thresholds may be used to determine the most efficient switching points between various available configurations. This adaptation scheme switches configuration based on the system load, independent of time.

In an embodiment, hysteresis may be used to prevent toggling between multiple configurations. The system load may be mapped to a point near a threshold between two configurations. If no hysteresis is employed, then even relatively small variations in the system load may result in continual switching between the two configurations. This may then degrade system performance because certain costs are normally associated with each switch between two configurations.

In one implementation, time hysteresis is used to prevent toggling between two configurations. With time hysteresis, the system does not switch over to a new configuration unless a particular amount of time has passed since the switch to the current configuration. Whenever a switch to a new configuration is made, a timer may be reset (e.g., to zero). Thereafter, a switch over to another configuration is not considered until the timer value exceeds a particular time threshold. If the amount of time elapsed since the last switch is less than this time threshold, then the current configuration is retained. The time threshold may be selected as any value determined to provide good system performance (e.g., 1 minute, 15 minutes, 30 minutes, 1 hour, or some other value).

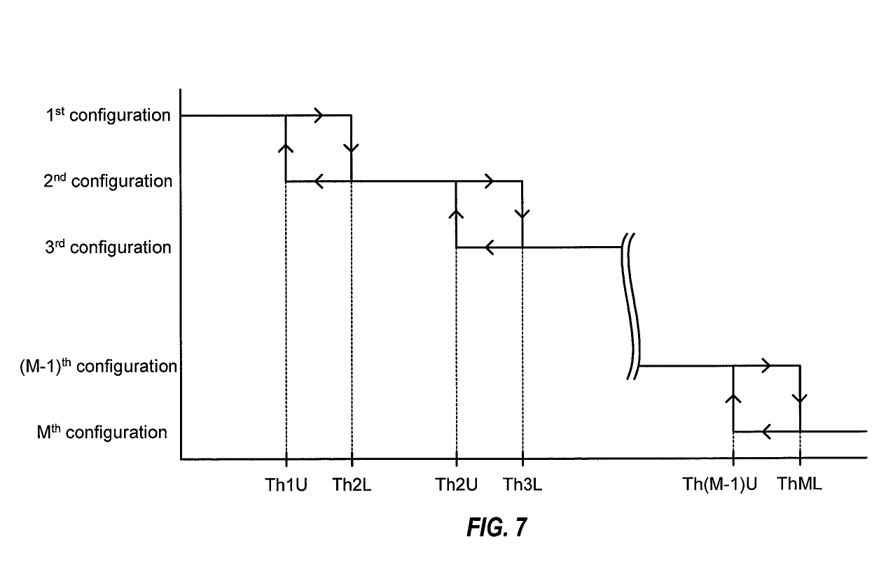

FIG. 7 is a diagram that illustrates the use of load hysteresis to prevent toggling between two configurations. With load hysteresis, the system does not switch over to a new configuration unless the system load changes by a particular amount. In the embodiment shown in FIG. 7, two thresholds are provided for switching between each pair of configurations. Each threshold may be represented by any combination of values for voice and packet data performance (e.g., any set of values for Erlangs and kbps/sector).

For example, while in the first configuration, the system does not switch to the second configuration unless the system load exceeds the threshold TH2L. And while in the second configuration, the system does not switch back to the first configuration unless the system load falls below the threshold TH1U. The distance between the thresholds TH1U and TH2L may be set such that small variations in the system load do not cause toggling between the two configurations. Similar pairs of thresholds may be used for other pairs of configurations, as shown in FIG. 7.

Other implementations for hysteresis may also be contemplated and are within the scope of the invention. For example, both time and load hystereses may be employed whereby the configuration is not switched unless a particular amount of time has passed and the load has changed by a particular amount. The time and/or load thresholds to be used to implement hysteresis may be determined based on computer simulations, empirical measurements, or via some other means.

In another adaptation scheme, the system may be automatically switched at scheduled times. The scheduled times may be selected based on various considerations such as the usage characteristics of the system. For example, it may be determined that higher volume of voice calls is typically received during morning and evening commuting hours when many users are on the road, and higher volume of data calls is typically received during late evening hours and on weekends when users are at home and more likely to surf the Internet. This information may then be used to select a specific configuration that can best support the characterized usage for each characterized time interval. At each scheduled time, the selected configuration for the next time interval is automatically selected by the system. As the system load changes from the characterized usage during the time interval, the system may be evaluated and further adapted to more closely match the system capabilities to the load requirements.

The selection of a particular configuration to be used for a given system load may be based on various criteria. These criteria may be formulated into a cost function. The cost function may be applied to all configurations available for selection, and the configuration associated with the best cost function may be selected. For example, if the cost function relates to revenue, then the configuration that maximizes revenue would be the one selected for use. Voice and packet data requirements may be appropriately weighted in the cost function to derive the resultant value (e.g., revenue). The cost function may weigh voice service more, or may weigh packet data service more, or may weigh the two types of services equally.

The adaptation techniques described herein may be implemented by various means. For example, the adaptation techniques can be implemented with hardware, software, or a combination thereof. For a hardware implementation, the elements used for determine the system load and to select the proper configuration can be implemented within one or more application specific integrated circuits (ASICs), digital signal processors (DSPs), programmable logic devices (PLDs), controllers, micro-controllers, microprocessors, other electronic units designed to perform the functions described herein, or a combination thereof.

For a software implementation, the functions to adapt the system capabilities to the load requirements may be implemented with software modules (e.g., procedures, functions, and so on). The software code can be stored in a memory unit and executed by a processor (e.g., controller 640 in FIG. 6).

The foregoing description of the preferred embodiments is provided to enable any person skilled in the art to make or use the present invention. Various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. A method for adapting capabilities of a transmitter unit in a wireless communication system to load requirements, comprising:
characterizing capabilities of each of a plurality of configurations for a plurality of wireless technologies;
determining the load requirements for the transmitter unit;
selecting one of the plurality of configurations based on the characterized capabilities for the configurations and the determined load requirements; and
activating the selected configuration.

2. The method of claim 1, wherein the determining, selecting, and activating are performed periodically.

3. The method of claim 1, wherein the determining, selecting, and activating are performed continually.

4. The method of claim 1, wherein the load requirements are characterized for a plurality of time intervals and a particular configuration is selected for each time interval based on the characterized load requirements, and wherein the configuration selected for each time interval is automatically activated at a start of the time interval.

5. The method of claim 1, further comprising:
applying hysteresis in activating the selected configuration.

6. The method of claim 1, wherein the activating is enabled if an elapsed time since a last activating to a current configuration is greater than a particular time threshold.

7. The method of claim 1, wherein the configuration is further selected based on load thresholds.

8. The method of claim 7, wherein the load thresholds are selected to provide hysteresis when switching between configurations.

9. The method of claim 5, wherein the applying hysteresis includes determining a change in the load requirements since a last activating to a current configuration, and enabling the activating if the change in the load requirements is greater than a particular threshold.

10. The method of claim 1, wherein each of the plurality of configurations comprises a unique set of channels used for data transmission, with each channel corresponding to a particular wireless technology.

11. The method of claim 10, wherein each channel in the set is associated with a respective RF carrier.

12. The method of claim 10, wherein the channels in each set conforms to an overall available system bandwidth.

13. The method of claim 1, wherein the plurality of wireless technologies include at least one technology supportive of voice communication.

14. The method of claim 1, wherein the plurality of wireless technologies include at least one technology supportive of high data rate communication.

15. The method of claim 1, wherein the plurality of wireless technologies include at least one technology supportive of low to medium data rate communication.

16. The method of claim 1, wherein the plurality of wireless technologies include IS-856.

17. The method of claim 1, wherein the plurality of wireless technologies include cdma2000.

18. The method of claim 1, wherein the plurality of wireless technologies include IS-95.

19. The method of claim 1, wherein the plurality of wireless technologies include W-CDMA.

20. The method of claim 1, wherein the plurality of wireless technologies include GSM.

21. A method for adapting capabilities of a base station in a wireless communication system to load requirements, comprising:
characterizing capabilities of each of a plurality of configurations for a plurality of wireless technologies, wherein each configuration comprises a unique set of channels used for data transmission, with each channel corresponding to a particular wireless technology, and wherein the plurality of wireless technologies include at least one technology supportive of voice communication and at least one technology supportive of high data rate communication;
determining the load requirements for the base station;
selecting one of the plurality of configurations based on the characterized capabilities for the configurations and the determined load requirements;
activating the selected configuration; and
applying hysteresis in selecting the configuration or activating the selected configuration.

22. A base station in a wireless communication system, comprising:
a plurality of processing units, each processing unit operable to process data in accordance with a particular wireless technology for transmission on a designated channel, wherein the plurality of processing units implement a plurality of wireless technologies; and
a controller configured to determine load requirements for the base station, select one of a plurality of configurations of processing units based on characterized capabilities of the processing units and the determined load requirements, and activate the processing units in the selected configuration.

23. The base station of claim 22, further comprising:
a first switch operative to receive data designated for a plurality of terminals and to route the data to the processing units in the selected configuration.

24. The base station of claim 22, further comprising:
a receive processor operative to receive requests for a plurality of types of transmissions, and wherein the load requirements are determined based in part on the received requests.

25. The base station of claim 22, wherein the processing units are implemented as channel cards.

26. The base station of claim 25, wherein the channel cards are mounted on a common rack.
